(19) United States
(12) Patent Application Publication
(10) Pub. No.: US 2018/0228137 A1
(43) Pub. Date: Aug. 16, 2018

(54) Fishing Device, System and Method

(71) Applicant: Myles Everett Chumchal, Houston, TX (US)

(72) Inventor: Myles Everett Chumchal, Houston, TX (US)

(21) Appl. No.: 15/894,054

(22) Filed: Feb. 12, 2018

Related U.S. Application Data
(60) Provisional application No. 62/458,643, filed on Feb. 14, 2017.

(51) Int. Cl. A01K 89/08; A01K 89/00; A01K 89/015

(52) U.S. Cl. CPC A01K 89/081; A01K 89/0175; A01K 89/0183; A01K 89/009

(57) ABSTRACT

The present application is directed to a rodless hand held fishing device, including a main body and an actuation assembly. The fishing device may be assembled and disassembled as desired. The fishing device may include interchangeable parts providing for one or more particular fishing activities.

### CROSS-REFERENCE TO RELATED APPLICATIONS

This non-provisional patent application claims the benefit of and priority from U.S. provisional patent application No. 62/458,643 filed Feb. 14, 2017.

### STATEMENT REGARDING FEDERALLY SPONSORED RESEARCH OR DEVELOPMENT

Not applicable.

### FIELD OF THE APPLICATION

The application relates generally to the field of fishing devices including hand reels for accommodating fishing line.

### BACKGROUND OF THE APPLICATION

The conventional way to cast out a fishing line involves a long casting rod of four to eight feet in length with a reel attached to the rod. Typically, the rod is swung through an arc to build up centrifugal force at the forward tip of the rod. At a desired moment the reel is released causing the weighted fishing line to strip off the reel and be cast out through the forward tip of the rod. As fishermen understand, the conventional rod and reel has certain disadvantages. For example, a rod up to eight feet in length is often difficult to store and transport and such rods often get caught or snagged in tree branches and foliage near the edges of lakes, ponds, rivers and streams. Moreover, many fishermen have been hit with the fishing rod of another fisherman, particularly when multiple persons are fishing in close confines. In addition, conventional rod and reels have several moving parts that can be expensive to manufacturer for both right-handed and left-handed persons. Attempts have been made to produce smaller devices for fishing purposes, however, such devices are still difficult to carry on your person. Overcoming such shortcomings is desired.

### SUMMARY OF THE APPLICATION

The present application is directed to a rodless fishing device, including a main body and an actuation assembly attached to the main body, the actuation assembly including a drive member, a gearing system and a spool.

The present application is also directed to a rodless fishing device, including a main body and an actuation assembly releasably attachable to the main body; wherein the main body includes an aperture for receiving one or more fingers there through; and wherein the actuation assembly includes a cylindrical member for winding fishing line thereon and a manually operated drive member operationally configured to turn the cylindrical member. In one embodiment, the drive member may be operationally configured to turn the cylindrical member according to a gear ratio advantage. In one embodiment, the drive member may include a crank member and a handle pivotally attached thereto. In one embodiment, the crank member may include a ring gear. In one embodiment, the handle may be operationally configured to turn the cylindrical member at a gear ratio greater than a 1:1 gear ratio.

The present application is also directed to a method of fishing from a body of water for an individual, including (a) providing an individual with a system including fishing line, a hooking member attached to the fishing line and a rodless fishing device including (1) a main body and (2) an actuation assembly releasably attached thereto, wherein the actuation assembly includes a spool located on a first side of the main body for receiving wound fishing line thereon and a handle located on a second side of the main body, the handle being operationally configured to turn the spool; (b) the individual holding a predetermined length of fishing line with one hand and holding the main body with the other hand by placing the middle finger within the aperture and the index finger on the spool; (c) the individual tossing the hooking member toward the body of water while simultaneously releasing the index finger from the spool whereby the fishing line peels off from the spool; and (d) the individual turning the handle in a manner effective to turn the spool for winding fishing line onto the spool.

### BRIEF DESCRIPTION OF THE SEVERAL VIEWS OF THE DRAWING

FIG. 1 is a simplified illustration of a fishing device of this application including a handle set to an open position.

FIG. 2 is an outline of an exemplary main body of a fishing device including two circular apertures for finger placement.

FIG. 3 is an outline of an exemplary main body of a fishing device including a single aperture for finger placement.

FIG. 4 is an outline of an exemplary main body of a fishing device including three circular apertures for finger placement.

FIG. 5 is an outline of an exemplary main body of a fishing device including a single aperture for finger placement.

FIG. 6 is a sectional side view of the fishing device of FIG. 1.

FIG. 7 is an exploded view of the fishing device of FIG. 1.

FIG. 8 is a top view of a second section of the main body of the fishing device of FIG. 1 including planetary gearing.

FIG. 9 is a side view of a central gear in a resting position.

FIG. 10 is a side view of the central gear of FIG. 9 in an operable position.

FIG. 11 is a perspective view of a line spool of this application.

FIG. 12 is a perspective view of another embodiment of the fishing device of this application.

FIG. 13 is a sectional perspective view of another embodiment of the fishing device of this application.

FIG. 14 is a top view of a second section of the main body of the fishing device of FIG. 13 including spur gears.

FIG. 15 is a side partial phantom view of another embodiment of the fishing device of this application.

FIG. 16 is a perspective view of another embodiment of the fishing device of this application including a handle assembly in a closed position.

FIG. 17 is a perspective view of the fishing device of FIG. 16 including a handle assembly at a partially open position.

FIG. 18 is a perspective view of the fishing device of FIG. 16 including a handle assembly at a fully open position.

FIG. 19 is a perspective view of another embodiment of the fishing device of this application.

FIG. 20 is a simplified illustration of a person holding the fishing device of FIG. 1 in the left hand during part of the act of fishing.

FIG. 21 is another simplified illustration of a person using the fishing device of FIG. 1 in another part of the act of fishing.

FIG. 22 is another simplified illustration of a person using the fishing device of FIG. 1 in another part of the act of fishing.

FIG. 23 is another simplified illustration of a person using the fishing device of FIG. 1 in another part of the act of fishing.

FIG. 24 is a perspective view of another embodiment of the fishing device of this application.

FIG. 25 is a perspective exploded view of another embodiment of the fishing device of this application.

FIG. 26 is a sectional side view of the fishing device of FIG. 1.

FIG. 27 is a top view of a second section of the main body of the fishing device of FIG. 1 including planetary gearing.

FIG. 28 is a simplified illustration of the person of FIG. 23 operating the handle of the fishing device with the left hand.

### BRIEF DESCRIPTION

Before describing the invention in detail, it is to be understood that the present device, system and method are not limited to particular embodiments. It is also to be understood that the terminology used herein is for the purpose of describing particular embodiments only, and is not intended to be limiting. As used in this specification and the appended claims, the term “fishing” and like terms refers to “the activity of casting and reeling a fishing line alone, or in an attempt to catch marine animals including, but not necessarily limited to fish attached thereto. Marine animals may include fresh water and saltwater animals. Herein, “CNC machine” refers to a computer numerical control machine including, but not necessarily limited to mills, lathes, plasma cutters, electric discharge machining (EMD), multi-spindle machines, water jet cutters, wire EMI), and sinker EMI). The term “3D printing” or “additive manufacturing” as such terms are known by the skilled artisan, suitably refer to producing three-dimensional objects from materials including, but not necessarily limited to printable polymers and metal powders. As understood by persons of ordinary skill in the art, the term “fishing swivel” refers to a device consisting of two rings connected to a pivoting joint of a ball or barrel-shape. In operation, a fishing line from a reel is tied to one end of a fishing swivel and a fishing line terminating with a hook, fishing lure or sinker, is clipped or otherwise connected to the other end of the fishing swivel. One exemplary type of fishing swivel includes, but is not necessarily limited to a snap fishing swivel. For purposes herein, the phrase “hooking member” may refer to one or more fishing lures, one or more fishing lure with bait attached thereto, one or more angles or hooks, one or more angles or hooks with bait attached thereto, and combinations thereof. As understood by persons of ordinary skill in the art of fishing, a “rod” or “fishing rod” includes a long, typically flexible stick or pole shaped object attached to a fishing line ending in a hooking member. Herein, the term “drag” refers to the release of fishing line from the fishing device upon resistance being applied to the line, e.g., a marine animal or inanimate object pulling on the fishing line, in order to keep the fishing line from snapping or breaking.

In one aspect, the application provides a fishing device effective to cast and reel in a hooking member and/or catch and reel in marine animals, all without use of a fishing rod. As such, the present fishing device may be referred to as a “rodless” or “rod-free” fishing device. In one implementation, the fishing device may include a crank and gears effective to drive the device with a gear ratio advantage. In another implementation, the fishing device may include a crank member with an internal ring gear to drive the device. In another implementation, the fishing device may be provided without any gearing.

In another aspect, the application provides a fishing device including a planetary gear driving system effective for producing a device of compact size and design.

In another aspect, the application provides an ambidextrous fishing device that does not require any reassembly or changing of component parts for operation in either a right-handed or left-handed orientation.

In another aspect, the application provides a fishing device small enough in size to be carried in a typical size pocket of a person's clothing.

In another aspect, the application provides a fishing device that may be held with fingers alone without necessarily employing the palm of either hand.

In another aspect, the application provides a fishing device comprised of various component parts that may be assembled and disassembled in a manner effective for the replacement of component parts or cleaning of component parts for reuse.

In another aspect, the application provides a fishing device operationally configured for use with various types of fishing line of varying strength. As such, the present fishing device is operationally configured for use in a plurality of settings for catching marine animals including both freshwater and saltwater fish of various types and sizes.

In another aspect, the application provides a fishing device that may be built to scale. As such, the fishing device of this application may be provided in any size desired according to a particular person's individual needs. For example, an adult person typically has larger hands than a child. As such, the present fishing device may be provided in different sizes for optimum usage according to a person's individual bare hand size.

In another aspect, the application provides a system for fishing, the system including a rodless fishing reel device, a fishing line to be wound on the device and a hooking member to be secured to the fishing line. The system may also include a fishing swivel as desired.

In another aspect, the application provides a fishing device defined by an assembly of component parts operationally configured to be assembled for use and disassembled as desired. In addition, the fishing device is operationally configured for ease of storage and transportation in something as small as a pocket on clothing while being effective for catching saltwater and fresh water fish.

In another aspect, the application provides a method of fishing from a body of water for an individual, including providing an individual with a system including fishing line, a hooking member attached to the fishing line and a rodless fishing device including (1) a main body and (2) an actuation assembly releasably attached thereto, wherein the main body has (a) a first section defining a first side of the main body, (b) a second section defining a second side of the main body and (c) at least one aperture for receiving one or more fingers there through, and wherein the actuation assembly includes a spool located on the first side of the main body for receiving wound fishing line thereon and a handle located on the second side of the main body, the handle being operationally configured to turn the spool; the individual holding a predetermined length of fishing line with one hand and holding the main body with the other hand by placing the middle finger within the aperture and the index finger on the spool; the individual tossing the hooking member toward the body of water while simultaneously releasing the index finger from the spool whereby the fishing line peels off from the spool; and the individual turning the handle in a manner effective to turn the spool for winding fishing line onto the spool.

In another aspect, the application provides a rodless fishing device, including a main body and an actuation assembly attached to the main body, the actuation assembly including at least one component part located external the main body, at least one component part located within the main body and at least one component part located partially external the main body and partially within the main body.

In another aspect, the application provides a rodless fishing device, including a main body and an actuation assembly releasably attachable to the main body; wherein the main body includes an aperture for receiving one or more fingers there through; and wherein the actuation assembly includes (1) a cylindrical member for winding fishing line thereon and (2) a manually operated drive member operationally configured to turn the cylindrical member.

In another aspect, the application provides a rodless fishing device, including a main body and an actuation assembly attached to the main body, the actuation assembly including a drive member, a gearing system and a spool. The gearing system may be housed within the main body. The spool and the drive member may be located on opposing sides of the main body. The spool and drive member may be turnable about a first axis, or, in the alternative the spool may be turnable about a first axis and the drive member may be turnable about a second axis. The main body is operationally configured to be held by a bare hand of an individual. The drive member includes a crank member and a handle pivotally attached to the crank member wherein the handle is operationally configured to be held by a first bare hand of an individual and the main body is operationally configured to be held by an opposing second bare hand of the individual and wherein the handle is operationally configured to act on the gearing system in a manner effective to turn the spool. The spool is defined by a central axis and includes an outer surface for winding fishing line thereon, the spool includes an outer brim operationally configured for unwinding of fishing line off from the spool according to a direction parallel to the central axis of the spool and the spool further includes an inner brim, whereby the inner brim and main body abut to form a mating surface operationally configured to prevent fishing line from traveling between the spool and main body. The gearing system may include a gear ratio advantage.

In another aspect, the application provides a rodless fishing device, including (1) a main body and (2) an actuation assembly attached to the main body, the actuation assembly including at least one component part located external the main body, at least one component part located within the main body and at least one component part located partially external the main body and partially within the main body. The main body may include a first section defining a first side of the main body and a second section releasably attachable to the first section defining a second side of the main body. The actuation assembly may include a component part having a surface external the first side of the main body operationally configured for winding fishing line thereon and at least one component part located external the second side of the main body. The actuation assembly may include a spool on the first side of the main body and a handle located external the second side of the main body that is operationally configured to turn the spool according to a gear ratio advantage. The actuation assembly may include a gearing system located within the main body. The main body may include at least one aperture there through operationally configured to provide a contact surface for one or more fingers of a user of the fishing device.

### Discussion

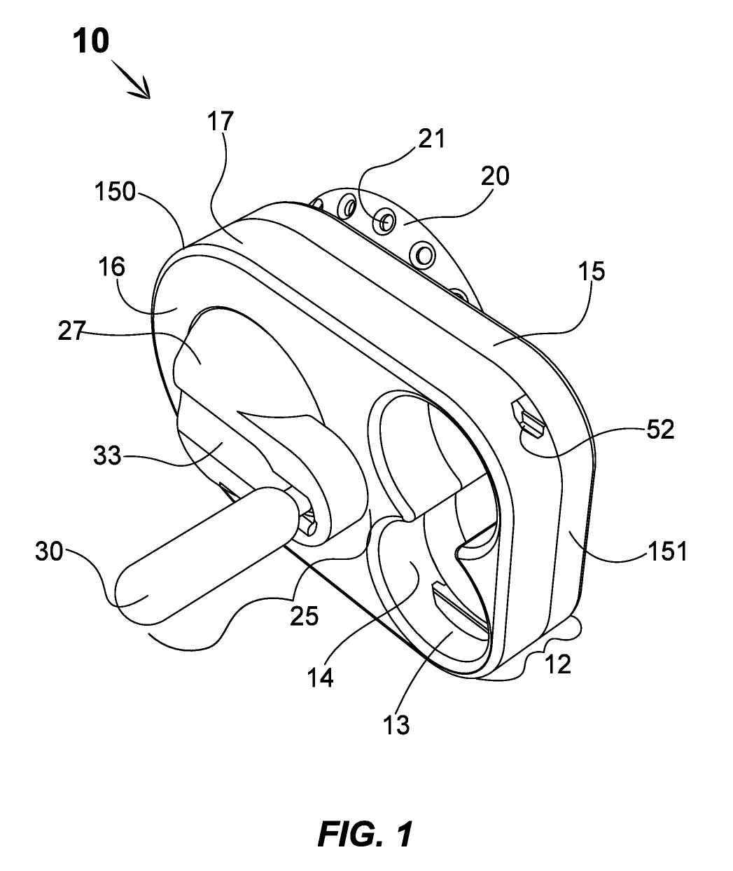

With reference to FIG. 1, in one embodiment the fishing device 10 may be comprised of a plurality of first component parts operationally configured for assembly in a manner effective to form a main body 12 of the fishing device 10. The fishing device 10 also includes a plurality of second component parts operationally configured to be assembled to the main body 12 in a manner effective to provide for actuation of the fishing device 10—such second component parts may be referred to herein collectively as an “actuation assembly” of the fishing device 10. As discussed below, various component parts of an actuation assembly may be referred to herein as “external actuation members” while other component parts of an actuation assembly may be referred to herein as “internal actuation members.” The actuation assembly and the main body 12 as described herein are suitably assembled in a manner effective to provide a fishing device 10 for one or more fishing activities known to fishermen.

Still referring to FIG. 1, one main body 12 of the fishing device 10 may be comprised of a first section 15 defining a first side of the fishing device 10 and a second section 16 releasably attachable to the first section 15 defining an opposing second side of the fishing device 10. Suitably, the outer perimeters of the first and second sections 15, 16 correspond in size and shape effective for providing an outer sidewall 17 defining the outer perimeter the main body 12 as shown. In one embodiment, the size and/or shape of each of first and second sections 15, 16 may vary according to the size of the components parts making up the actuation assembly of the fishing device 10.

Once assembled, the main body 12 suitably provides one or more external surfaces or outer surfaces for holding the fishing device 10 by bare hand or by another device such as a hand held tool or a prosthetic device. For purposes of this application, a hand of an individual may also include a glove thereon.

In this embodiment, each of the first and second sections 15, 16 suitably include a corresponding aperture there through, and once assembled, the first and second sections 15, 16 provide a single aperture 13 of the main body 12 near the back 151 of the fishing device 10 as shown. As shown, the aperture 13 is defined by an inner contact surface 14 effective for receiving a person's fingers therein in a manner effective for a person to hold the fishing device 10 with one or both hands as desired. As stated, the main body 12 of this embodiment includes a single aperture 13 with a contact surface 14 defining a “figure eight” type configuration including two large circular open sections and a narrow open section there between. In an embodiment of the fishing device 10 intended for adult use, each of the large circular open sections of the aperture 13 is suitably defined by inner diameter operationally configured to receive a single finger or digit therein. That said, in a scenario where a minor makes use of an adult sized fishing device 10, a minor person may have small enough hands allowing him/her to insert multiple fingers or digits within a single circular open section of the aperture 13.

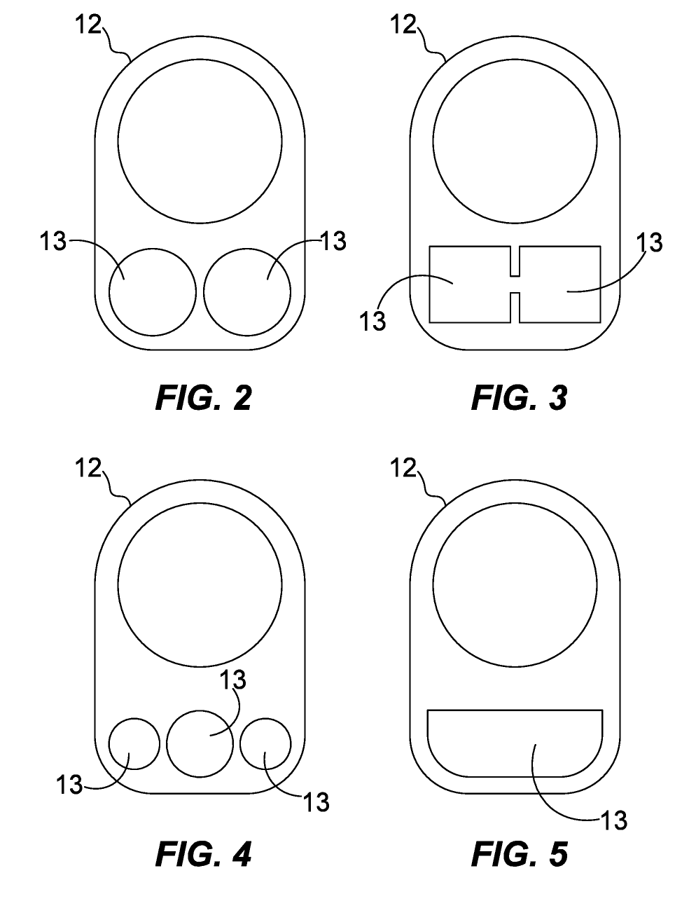

In another embodiment, a main body 12 may include two separate circular apertures 13 there through (see FIG. 2), each of the separate circular apertures 13 having an inner diameter substantially similar as, or different than, the inner diameter of the large circular open sections of the aperture 13 of FIG. 1. In another embodiment, a single aperture 13 may include a configuration other than a figure eight type configuration (see FIG. 3). In still another embodiment, the main body 12 may include three or more individual apertures 13 there through as shown in the simplified example of FIG. 4. As such, the overall size of the main body 12 may vary in order to accommodate a given number of apertures 13 of one or more particular sizes and/or shapes. In still another embodiment, a main body 12 may include one or more irregular shaped apertures 13 (see FIG. 5). As understood by the skilled artisan, other sizes, shapes and/or configurations different from the representations of FIGS. 2-5 are herein contemplated, including for example, oblong apertures 13, other multi-sided apertures 13 such as hexagonal, triangular, and other multi-sided shapes, irregular shaped apertures 13, and combinations thereof.

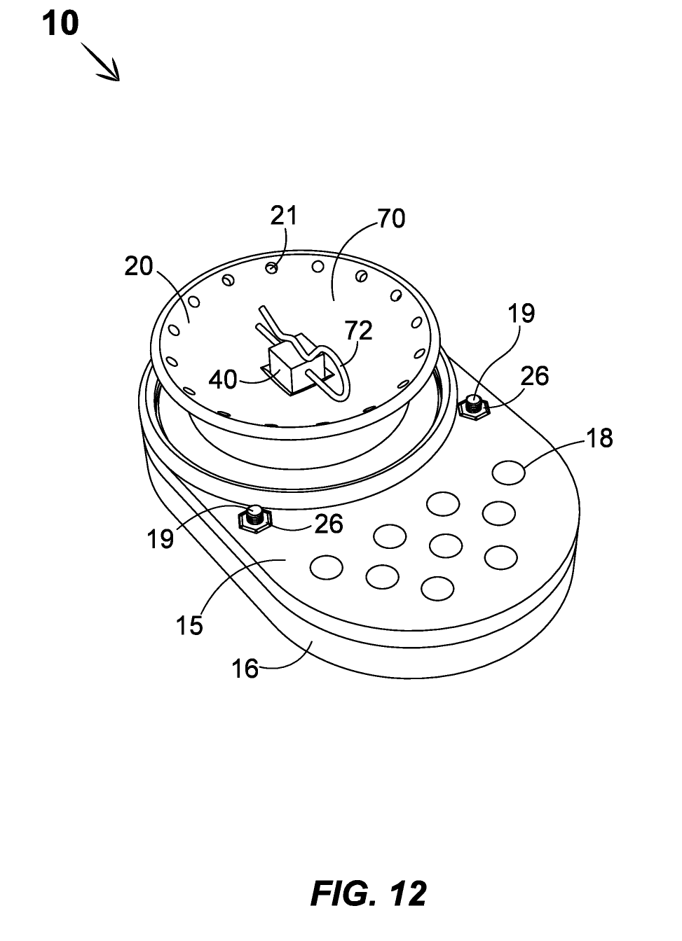

It is further contemplated that in another embodiment the main body 12 may be devoid of any apertures as shown in the simplified embodiment of FIG. 12. In one such embodiment, one or more sections of the outer surface of the main body 12 may be substantially planar or flat. In another embodiment, to enhance gripping of the main body 12 by hand, the outer surface of the first section 15 and/or the second section 16 may include one or more slip resistant features and/or materials including, but not necessarily limited to parallel rows of grooves therein, a plurality of raised bumps or protrusions 18 as shown in FIG. 12, a knurl pattern, recessed fingerprint type indicia and/or a tacky material applied to the surface of the main body 12 including, but not necessarily limited to one or more rubber materials. Other slip resistant surfaces for use herein are described in U.S. Pat. No. 6,075,221, titled “Mechanism and Method of Making Anti-slip Handles,” issued on Jun. 13, 2000; and U.S. Pat. No. 5,689,890, titled “Grip Surface,” issued on Nov. 25, 1997, the content of each of which is herein incorporated by reference in its entirety.

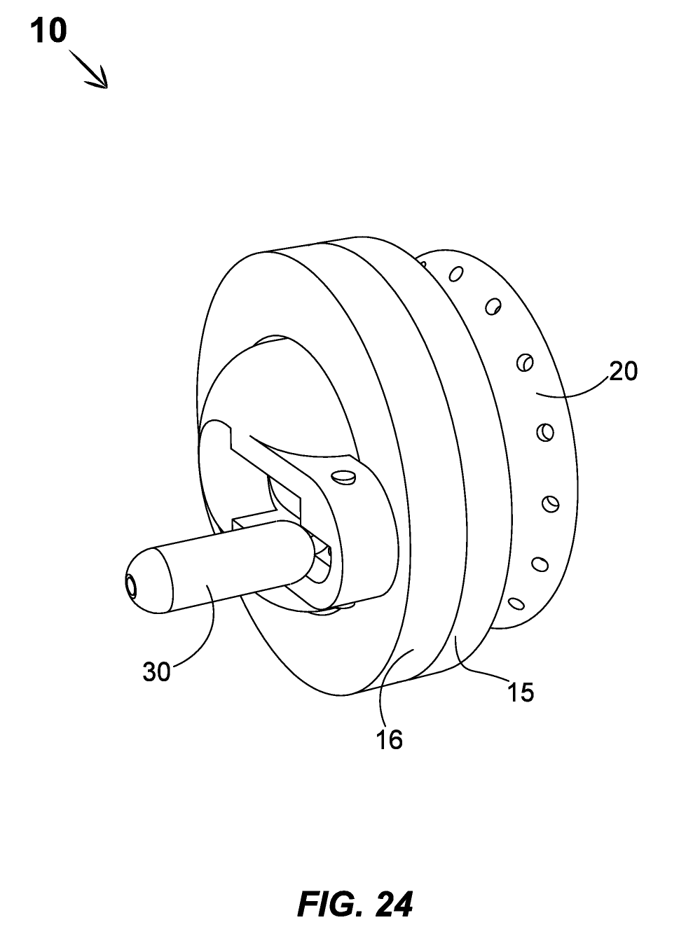

In another embodiment, the main body 12 may be provided as a single member or one piece construction as shown in FIG. 15. In still another embodiment, the fishing device 10 may be provided in a manner effective to minimize the materials of construction as shown in FIG. 24. In such embodiment, the fishing device 10 is suitably reduced to a main body 12 for enclosing the internal actuation members of the actuation assembly described below. Regardless of the configuration of the main body 12 employed, a user 99 suitably holds the main body 12 with one hand and holds the handle 30 with the opposite hand for operation of the fishing device 10.

Referring again to FIG. 1, suitable external actuation members for assembly with the first and second sections 15, 16 may include (1) a fishing line winding surface in the form of a cylindrical member (hereafter “line spool” or “spool 20”) located on the first side of the fishing device 10 for receiving a fishing line thereon and (2) a manually operated drive member 25 located on the second side of the fishing device 10 operationally configured to turn the spool 20.

One suitable spool 20 may be provided as a cylindrical member defined by a central axis that is operationally configured to receive fishing line in a wound manner around its outer surface, i.e., commonly referred to as spooling line. In one embodiment, the spool 20 may include a solid body with an axially aligned attachment surface. In another embodiment, the spool 20 may include an opening through its central axis as described below.

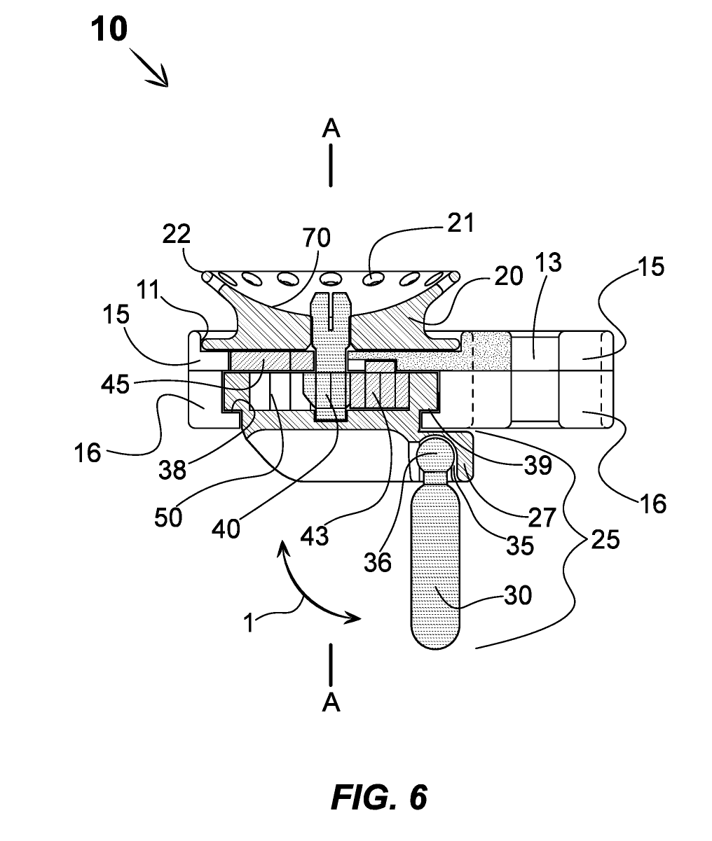

As understood by the skilled artisan, one suitable spool 20 may include a first widened surface or outer brim 22 as shown in FIG. 6 that is operationally configured similar as a flange on a bobbin effective to prevent wound fishing line from slipping off laterally from the spool 20. As also understood by the skilled artisan, the width of the winding surface 23 of the spool 20 is not necessarily limited to a width as shown in FIG. 6 in relation to the size of the main body 12. For example, in one embodiment, a spool 20 may be provided with a narrower winding surface 23 or a wider winding surface 23 than as shown in FIG. 6. For instance, a wider winding surface 23 may be desired for catching larger fish including, but not necessarily limited to saltwater fish such as redfish. In this regard, the present fishing device 10 may be provided with a plurality of interchangeable spools 20 of varying sizes for use as desired.

The drive member 25 suitably includes (1) a main turnable member (hereafter “crank member 27”) defined by a central axis and (2) a handle 30 pivotally attached to the crank member 27 that is operationally configured as a mechanical hand crank as such term is understood by the skilled artisan. As shown in FIG. 6, once assembled, the crank member 27 is concentrically aligned with the spool 20 along axis A-A effective for a user 99 to direct the handle 30 to turn the crank member 27 and the spool 20 about the axis A-A as described below. Suitably, the drive member 25 is sized to provide adequate torque without interrupting a person's finger placement along the outer surface of the main body 12 and/or within the one or more apertures 13 during operation of the fishing device 10.

The handle 30 as depicted in FIG. 1 includes an elongated member defined by a longitudinal axis. It is contemplated that other non-linear handles 30 may be employed as desired. One suitable non-linear handle 30 may include a curved configuration or have one or more bends. One suitable non-linear handle 30 for use herein is described in United States Patent Application Publication Number 20070204895, titled “Combined Walking Aid and Fishing Rod,” published on Sep. 6, 2007, the content of which is herein incorporated by reference in its entirety. Furthermore, the present fishing device 10 may be provided with a plurality of interchangeable handles 30 of varying shapes and/or sizes and/or lengths for use as desired.

One suitable handle 30 may be pivotally attached to the crank member 27 in a manner effective for directing the handle 30 between a closed position alongside the crank member 27 and an open position apart from the crank member 27. As shown in the embodiment of FIG. 1, the crank member 27 may include a mating surface 33 for receiving at least part of the handle 30 in abutment thereto when the handle 30 is set to a closed position for storage and/or transport. Without limiting the invention, a suitable mating surface 33 may include a size and shape substantially similar as at least part of the outer surface of a corresponding handle 30. For example, where a handle 30 includes a cylindrical outer surface, a corresponding mating surface 33 may include a curved surface as shown in FIG. 1 for engaging up to about 180.0 degrees of the outer surface of the handle 30. In another embodiment including a four-sided elongated handle 30, a mating surface 33 may include a planar abutment surface or floor with two opposing planar sidewalls at ninety-degrees providing a depth for receiving at least part of the handle 30 therein.

The type of pivotal attachment between the handle 30 and crank member 27 may vary as desired. For example, as shown in the embodiment of FIG. 6, the drive member 25 may be provided with a ball and socket type configuration whereby the crank member 27 includes a socket 35 for receiving a ball section 36 of a handle 30 therein in a manner effective to direct the handle 30 between a closed position and an open position according to directional Arrow 1. As understood by the skilled artisan, the socket 35 suitably includes an opening smaller than the outer diameter of the ball section 36 effective to maintain the ball section 36 within the socket 35. As also understood by the skilled artisan, the ball section 36 and/or the material forming the socket 35 opening may be flexible enough to allow the ball section 36 to be inserted into the socket 35 and/or be removed out from the socket 35. In addition to pivot action, the ball section 36 of the handle 30 may freely spin within the socket 35.

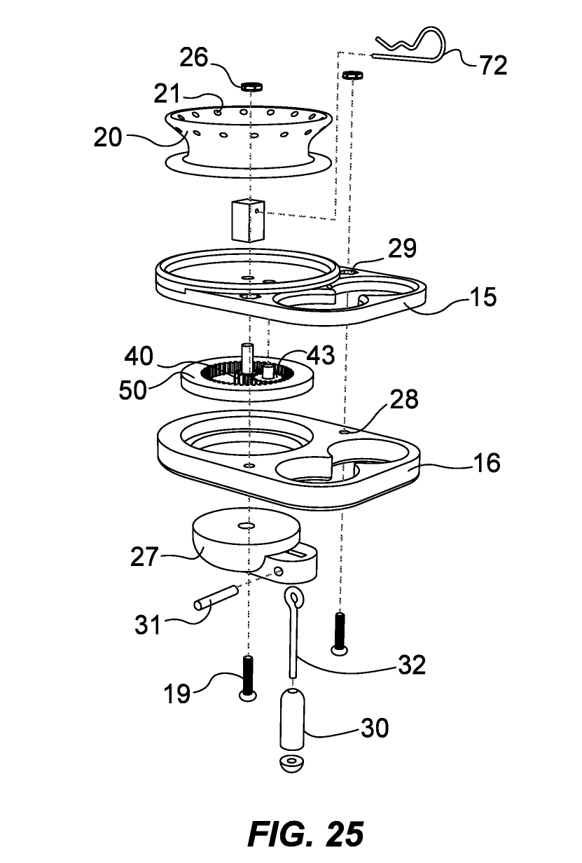

In another embodiment, a handle 30 may be attached to crank member 27 via a hinge allowing the handle 30 to pivot between a closed and open position according to directional Arrow 1. In another embodiment, a handle 30 may include a pin member 34 extending out from the surface of the handle 30 (see FIG. 15) in a manner effective to engage a mating surface of the crank member 27 for pivoting the handle 30 between a closed and open position according to directional Arrow 1. As shown in FIG. 25, in another embodiment the crank member 27 may include a pin member 31 operationally configured to mate with an open loop end or open loop part 32 of a handle 30 or handle assembly in a manner effective for the handle 30 or handle assembly to pivot about the pin member 31 between a closed and open position according to directional Arrow 1. In still another embodiment, a handle 30 may be provided as a detached or separate component that is operationally configured to engage a mating surface of the crank member 27 for turning the crank member 27 and spool 20 about axis A-A in a rotary fashion. In another embodiment, an object with a size and/or shape similar as a handle 30, such as an elongated tool, may be used for turning the crank member 27 and spool 20 about axis A-A. It is also contemplated that a motor may be employed for operating the crank member 27.

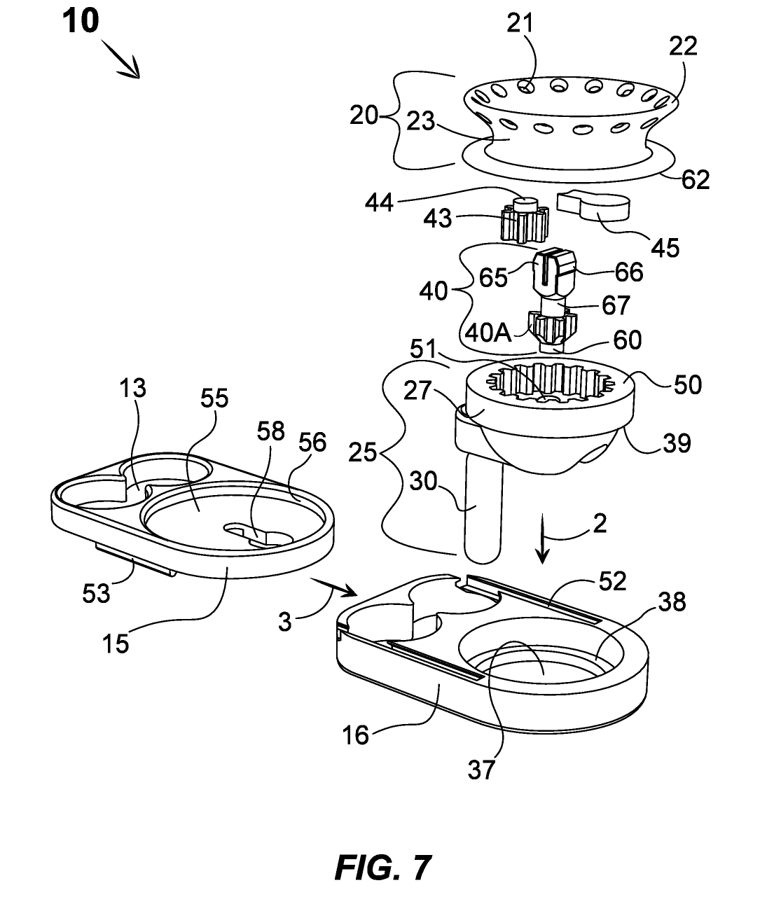

Turning to FIG. 7, the second section 16 of the main body 12 includes a circular opening 37 there through with a seat 38 disposed therein along the inner perimeter providing a first contact surface for receiving a corresponding second contact surface 39 of the crank member 27 in an abutment position—see directional Arrow 2. As such, the seat 38 is operationally configured to prevent the crank member 27 from passing through the circular opening 37 and orient the crank member 27 at a particular position or depth within the circular opening 37 for proper assembly of the fishing device 10.

With further reference to FIG. 7, the crank member 27 is provided as an open ended hollow member with an inner surface including an internal ring gear 50 defining the open end of the crank member 27. Suitably, the internal ring gear 50 is operationally configured to communicate with the spool 20 during operation of the fishing device 10. In particular, the crank member 27 is operationally configured to communicate with the spool 20 via internal actuation members including, but not necessarily limited to a gearing system such as planetary gearing or epicyclic gearing as understood by the skilled artisan. In this embodiment, the internal actuation members include a shaft gear or central gear 40, a planetary gear or “spur gear 43” and an optional stabilizing member or “key hole filler 45” operationally configured to intercommunicate the crank member 27 and the spool 20. The planetary gearing of this embodiment may be provided in a gear ratio advantage as desired. In one implementation, the planetary gearing may include a 3:1 gear ratio effective for fishing of fresh water and saltwater marine animals. As understood by the skilled artisan, the planetary gearing may be provided in a different gear ratio including, but not necessarily limited to a 4:1 gear ratio, a 2:1 gear ratio, a 5:1 gear ratio, and other gear ratios as may be desired.

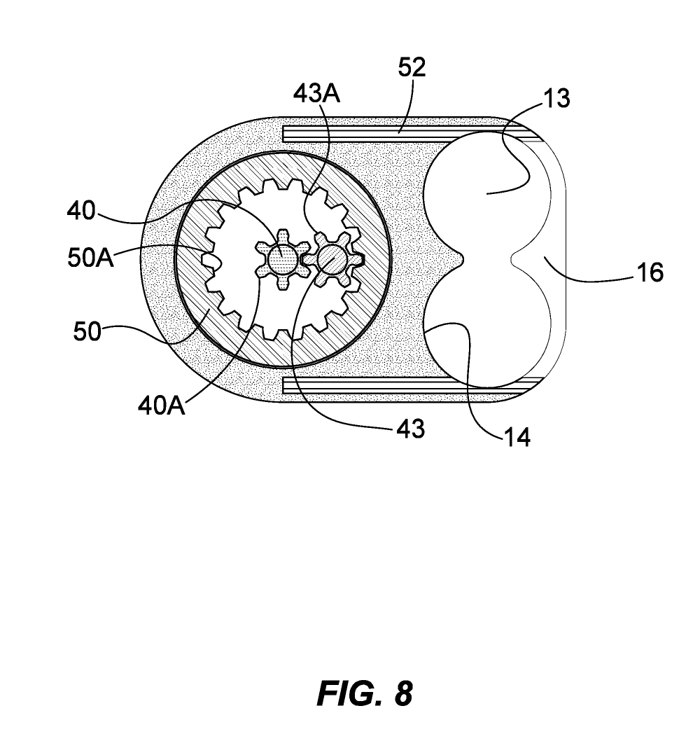

With reference to FIG. 8, a central gear 40 is suitably seated within the inner surface of the crank member 27 along axis A-A with the axle 44 of the spur gear 43 offset adjacent the central gear 40 interconnecting the central gear 40 with the ring gear 50. As understood by the skilled artisan, as the crank member 27 is turned about axis A-A, the teeth 50A of the ring gear 50 mesh with the teeth 43A of the spur gear 43, which in turn mesh with the teeth 40A of the central gear 40 to turn the central gear 40, which is in communication with the spool 20 in a manner effective to turn the spool 20. As such, in this embodiment the central gear 40 is effective as an axle for the spool 20.

Herein, operation of the planetary gearing is based on the interaction of the component parts once assembled as shown in FIG. 1. For example, not only are the first and second sections 15, 16 operationally configured to be secured together to form the main body 12, but the second section 16 is also operationally configured to communicate with the drive member 25 and the first section 15 is also operationally configured to interact with the remaining component parts comprising the actuation assembly for desired operation of the fishing device 10.

Referring again to FIG. 7, assembly of the various component parts suitably includes first inserting the drive member 25 into the circular opening 37 according to directional Arrow 2. Next, the first section 15 is attached to the second section 16 via a sliding action (see directional Arrow 3). As shown, a mating surface or mating side of the second section 16 includes elongated channels or grooves 52 along opposite sides of the second section 16 that are defined by open ends and closed ends as shown. Likewise, a mating surface or mating side of the first section 15 includes corresponding raised surfaces or ribs 53 operationally configured to be inserted lengthwise within the open ends of the grooves 52. In this embodiment, the ribs 53 are shown as elongated raised surfaces. In another embodiment, one or both sides of the first section 15 may include multiple inline raised surfaces rather than a single solid elongated rib 53 as depicted. In still another embodiment, a first section 15 may be provided with only a single rib 53 effective for joining the first and second sections 15, 16 to form the main body 12. As further shown in FIG. 7, the grooves 52 and ribs 53 are situated on each of the first and second sections 15, 16 in a manner effective for the closed ends of the grooves 52 to act as stops for the ribs 53 providing an even side wall 17 of the main body 12 as shown in FIG. 1.

In one embodiment, the configuration of the first and second sections 15, 16 may alone be effective for maintaining the main body 12 in a secured position as shown in FIG. 1. In another embodiment, the fishing device 10 may include one or more fasteners 19 or fastener assemblies operationally configured to further secure the first and second sections 15, 16 together. As depicted in FIG. 25, the first and second sections 15, 16 may include apertures 28, 29 operationally configured to receive threaded fasteners 19 such as screws or bolt type fasteners there through. For example, one or more nuts 26 and threaded bolts 19 may be used for securing the first and second sections 15, 16 as shown in FIG. 12. In another embodiment, the apertures 28, 29 may be provided as threaded apertures for threadedly mating with threaded fasteners 19 without the use of a nuts 26.

As further shown in FIG. 7, the non-mating side of the first section 15 includes a recessed circular mating surface 55 defined by a perimeter sidewall 56 with an inner diameter effective for receiving at least part of the spool 20 therein. The mating surface 55 includes an irregular shaped aperture or “key hole 58” there through operationally configured to receive the central gear 40 and spur gear 43 during assembly of the fishing device 10. In particular, the key hole 58 suitably extends from a centered position along the mating surface 55 out toward the perimeter sidewall 56 and includes a shape and size suitable for receiving the spur gear 43 and central gear 40 there through. As such, once the first section 15 is slid onto the second section 16 about halfway, (1) the spur gear 43 may be directed through the portion of the key hole 58 near the perimeter sidewall 56 and (2) a proximal end 60 of the shaft of the central gear 40 may be directed through the portion of the key hole 58 near the center of the mating surface 55 effective for aligning the central gear 40 according to axis A-A when the fishing device 10 is assembled. Suitably, the teeth 40A of the central gear 40 and the spur gear 43 rest within the cavity 51 of the drive member 25 as shown in FIG. 6. As shown, the central gear 40 suitably extends through the key hole 58 a distance according to the length of the central gear 40.

Once the spur gear 43 and central gear 40 are mated with the key hole 58, the first section 15 may be slid the remaining distance onto the second section 16 according to the configuration of the grooves 52 and ribs 53 forming the main body 12. As shown in FIG. 7, the key hole filler 45 suitably includes a shape corresponding to the portion of the key hole 58 near the perimeter of the mating surface 55. As such, the key hole filler 45 may be set within the key hole 58 in a manner effective to stabilize the central gear 40 adjacent thereto. In one embodiment, the size of the key hole 58 and key hole filler 45 provide for a snug snap type fit effective to maintain the key hole filler 45 in a fixed position effective to stabilize the central gear 40.

Suitably, the key hole filler 45 includes a thickness effective for resting within the key hole 58 flush with the mating surface 55. As such, once the key hole filler 45 is set in place within the key hole 58, the second widened surface or inner brim 62 of the spool 20, which has an outer diameter substantially similar as the inner diameter of the mating surface 55, may be set within or snap fit within the recessed mating surface 55 (see FIG. 6) as the final step of assembly of the fishing device 10 whereby the spool 20 is operationally configured to freely turn within the mating surface 55.

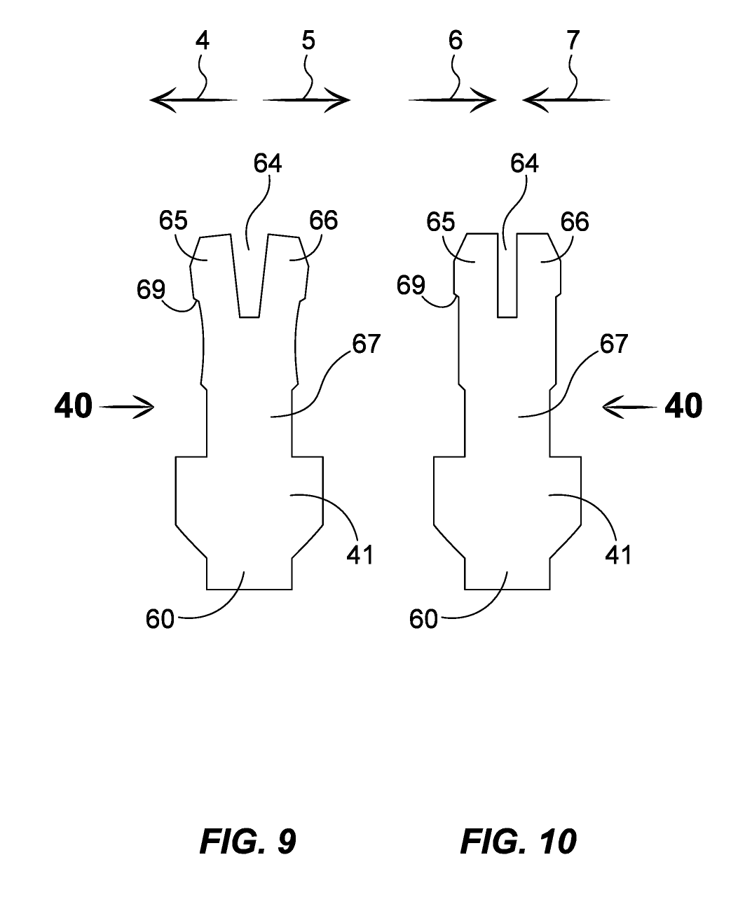

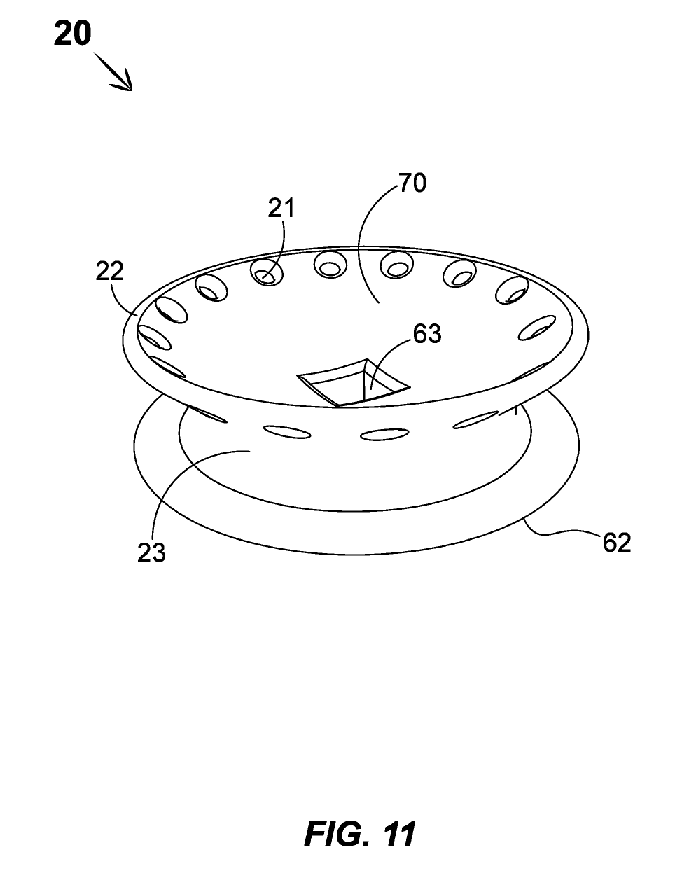

With reference to FIGS. 9-11, the distal end of the central gear 40 suitably has an elongated opening or slit 64 along its central axis at a depth effective for dividing the distal end into two separate end members 65 and 66. As depicted in FIG. 9, in a resting state the end members 65, 66 are operationally configured to bias in opposite directions according to directional Arrows 4 and 5. As stated above, the spool 20 may be provided with an aperture 63 there through. Thus, during assembly, as the central gear 40 is mated with the aperture 63 of the spool 20 the inner surface of the aperture 63 is operationally configured to contact and bias each of the end members 65, 66 inward according to directional Arrows 6 and 7, i.e., inward toward the central axis of the central gear 40, thereby narrowing the slit 64 as shown in FIG. 10. In this embodiment, the distal end of the central gear 40 is larger than the main shaft 67 or axle of the central gear 40. As such, once the spool 20 has been completely mated with the central gear 40, a skirt surface 69 of the distal end of the central gear 40 is operationally configured as a catch for contacting the outer face 70 of the spool 20 near the perimeter of the aperture 63 as shown in FIG. 6.

With attention to FIG. 12, in another embodiment, the distal end of the central gear 40 may include an aperture there through running perpendicular to the central axis of the central gear 40 in a manner effective to receive a pin 72 there through for maintaining the spool 20 in a fastened position with the central gear 40. Various types of pins may be employed. One suitable pin 72 includes, but is not necessarily limited to a cotter pin as shown.

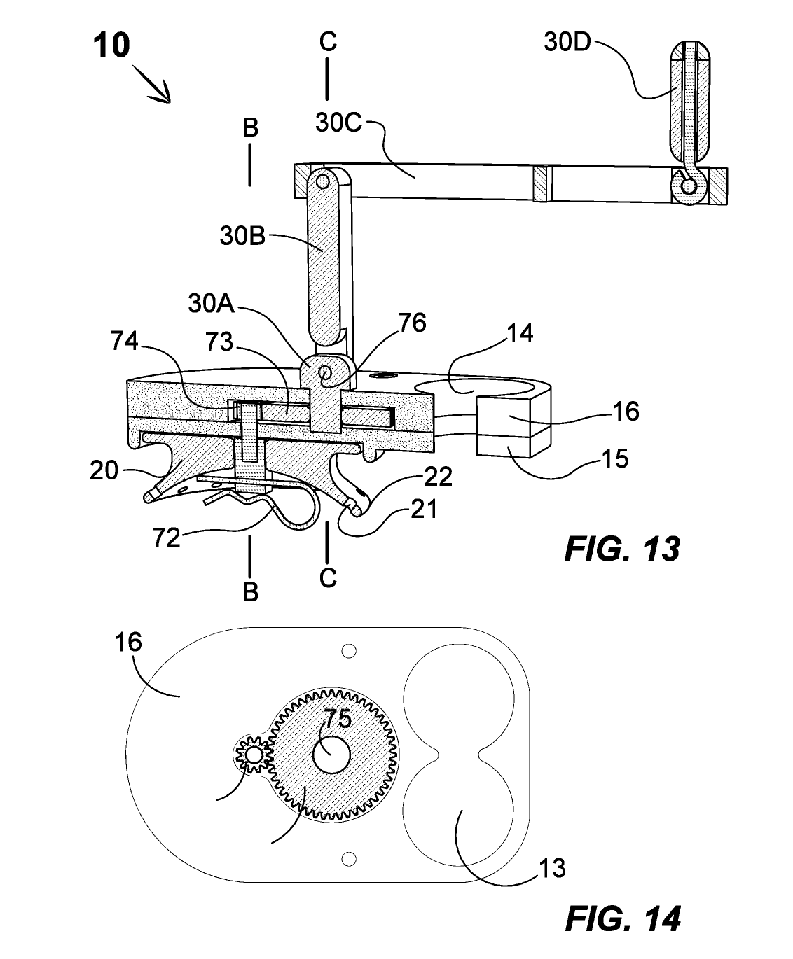

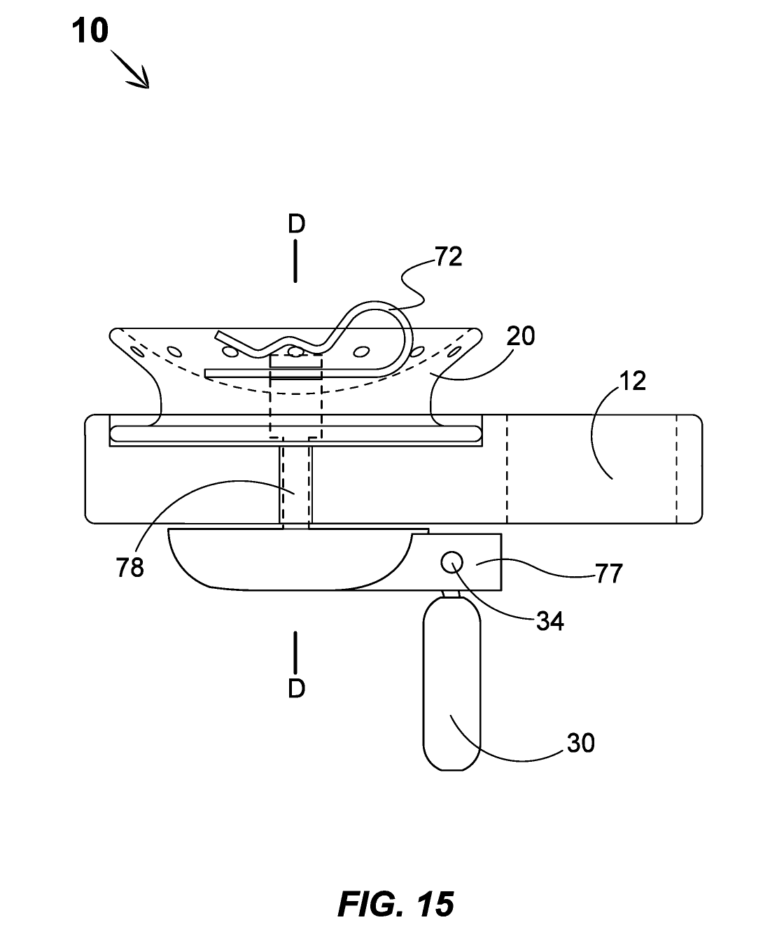

Another implementation of the fishing device 10 is depicted in FIGS. 13 and 14. In this embodiment, the actuation assembly makes use of spur gears 73, 74 rather than planetary gearing as described above. The actuation assembly also makes use of a multi-part handle 30 operationally configured to turn the larger spur gear 73 about axis B-B, whereby the larger spur gear 73 acts on the smaller spur gear 74 to turn the spool 20 connected thereto. As shown, the multi-part handle 30 includes a first handle member 30A operationally configured to mate with an aperture 75 of spur gear 73 in a manner effective to turn the spur gear 73. Suitably, the first handle member 30A may be secured to the spur gear 73 as desired, e.g., adhered to the spur gear 73 or provided as one piece construction. The handle 30 also includes a second handle member 30B pivotally attached to the first handle member 30A via a pivot pin 76. As shown, the second handle member 30B includes an elongated member axially aligned with the first handle member 30A along axis C-C in parallel alignment with axis B-B during operation of the fishing device 10.

The handle 30 also includes a third handle member 30C provided as an elongated member pivotally attached to the second handle member 30B. As shown, the third handle member 30C is defined by a longitudinal axis oriented substantially perpendicular to the longitudinal axis C-C during operation of the fishing device 10. Optionally, the handle 30 may include a fourth handle member 30D pivotally attached to the third handle member 30C for handheld operation. One suitable fourth handle member 30D may include an elongated member having a longitudinal axis oriented substantially parallel to axis B-B and C-C during operation of the fishing device 10 thereby providing a handle 30 functionally similar as single and dual knob handles of commercially available fishing reels—see, for example, the handle described in U.S. Pat. No. 8,011,610, titled “Fishing Reel Handle Assembly,” issued on Sep. 6, 2011, the content of which is herein incorporated by reference in its entirety.

Still another embodiment of the fishing device 10 is depicted in FIG. 15. In this embodiment, the actuation assembly is provided without gears. In particular, the actuation assembly includes a crank member 77, a central shaft member 78 and a spool 20, each of which is concentrically aligned about axis D-D. In this embodiment, the actuation assembly includes a direct connection between the crank member 77, the central shaft member 78 and the spool 20 in a direct drive 1:1 ratio, whereby turning action of the crank member 77 dictates turning action of the spool 20. As shown, the actuation assembly may also include a handle 30 pivotally attached to the crank member 77 in a manner effective to turn the crank member 77, central shaft member 78 and spool 20 about axis D-D.

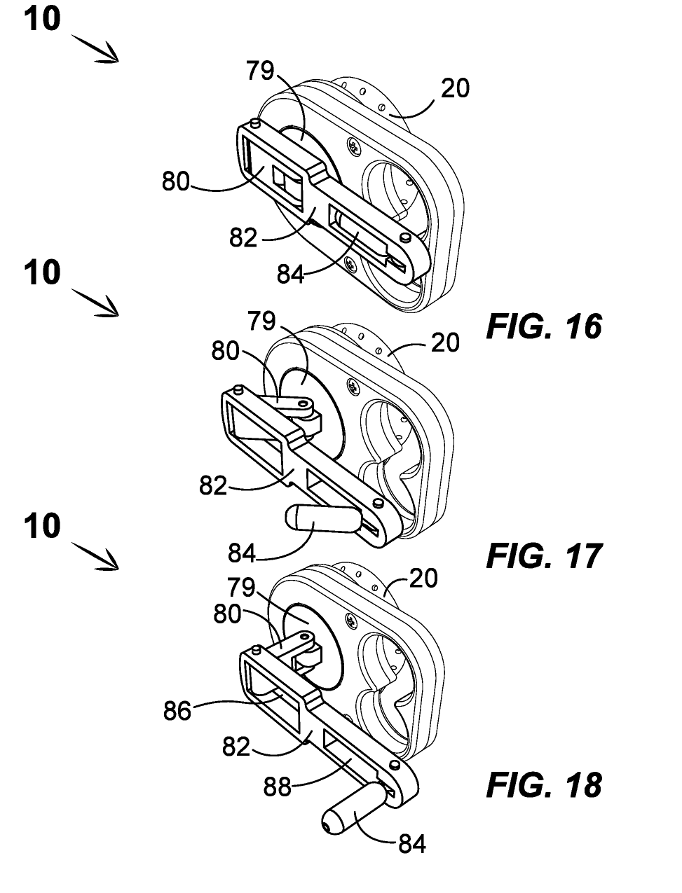

Turning to FIGS. 16-18, in another embodiment the fishing device 10 may include a fold out type handle assembly. As shown, the handle assembly may include a first section 80 having a proximal end in pivotal attachment with the crank member 79 and a distal end in pivotal attachment with a proximal end of a second section 82 of the handle 30. A shown, a proximal end of a third section 84 may be pivotally attached to a distal end of the second section 82. Suitably, the second section 82 includes a first opening 86 there through for receiving the first section 80 therein when the handle is set to a folded or closed position as shown in FIG. 16. The second section 82 also includes a cavity or second opening 88 there through for receiving the third section 84 therein when the handle is set to a folded or closed position as shown in FIG. 16.

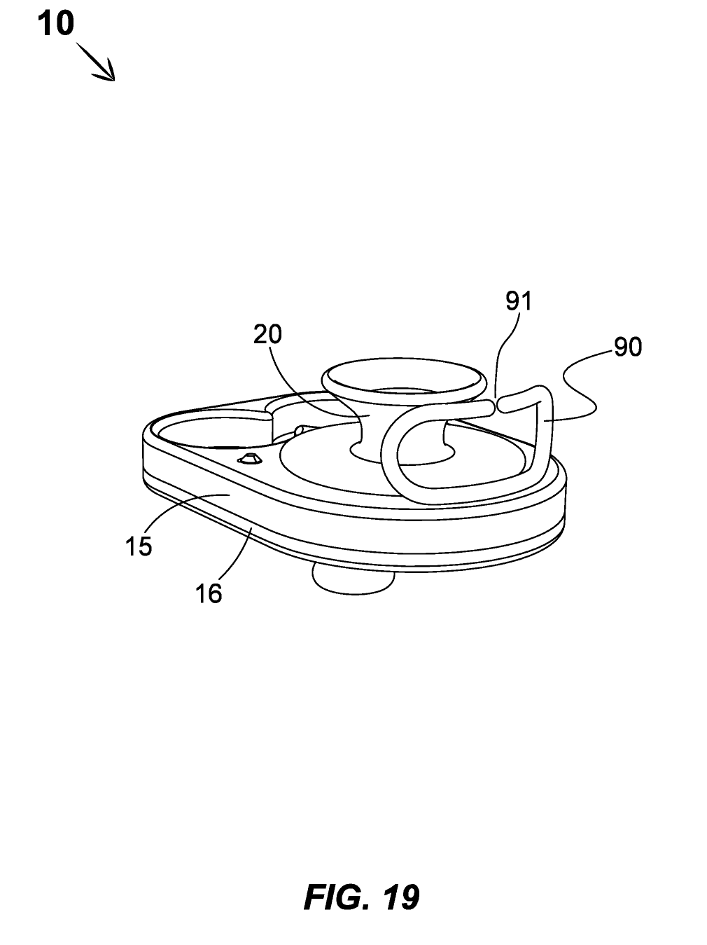

As shown in FIG. 19, the fishing device 10 may also include a line guide 90 disposed along the first section 15 that is operationally configured to assist in winding fishing line 100 onto the spool 20 as a cast fishing line 100 is being retrieved. In suitable operation when casting a fishing line 100, a user 99 pulls the fishing line 100 out apart from the line guide 90 via an opening 91 in the ling guide 90 and, before retrieving the fishing line 100, the user 99 places the fishing line 100 back within the line guide 90 through the opening 91. One suitable line guide 90 may be adhered to the first section 15, or in the alternative, a first section 15 may be manufactured to include a line guide 90 as part of the first section 15.

In one suitable embodiment, the spool 20 may be inset along the first section 15 in a manner effective to prevent the fishing line 100 from traveling between the spool 20 and the first section 15. For example, as shown in the embodiment of FIG. 6 the fishing device 10 may include a brim guide 11 or inner brim mating surface formed between the abutment of the second widened surface 62 of the spool 20 and the perimeter sidewall 56 of the recessed circular mating surface 55 of the first section 15. Such abutment or mating configuration is operationally configured to assist in winding fishing line 100 onto the spool 20 as a cast fishing line 100 is being retrieved by preventing the fishing line 100 from winding around the central gear 40 between the spool 20 and the mating surface 55.

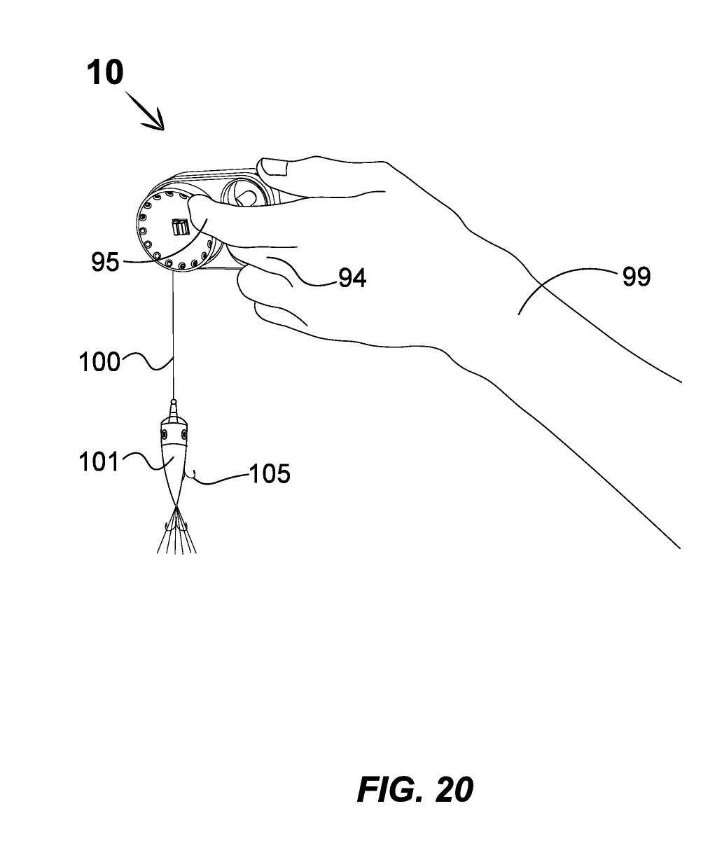

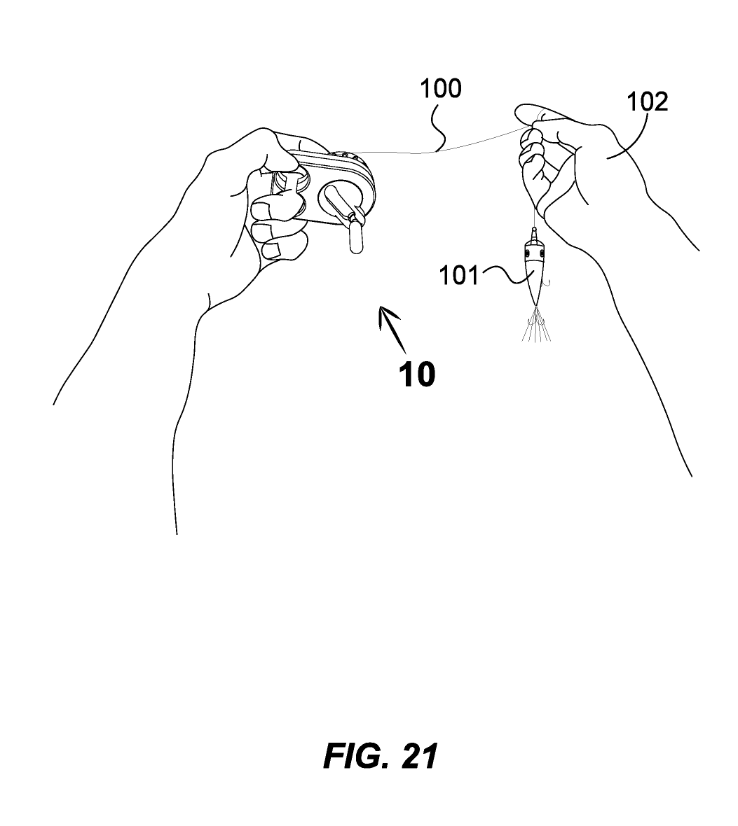

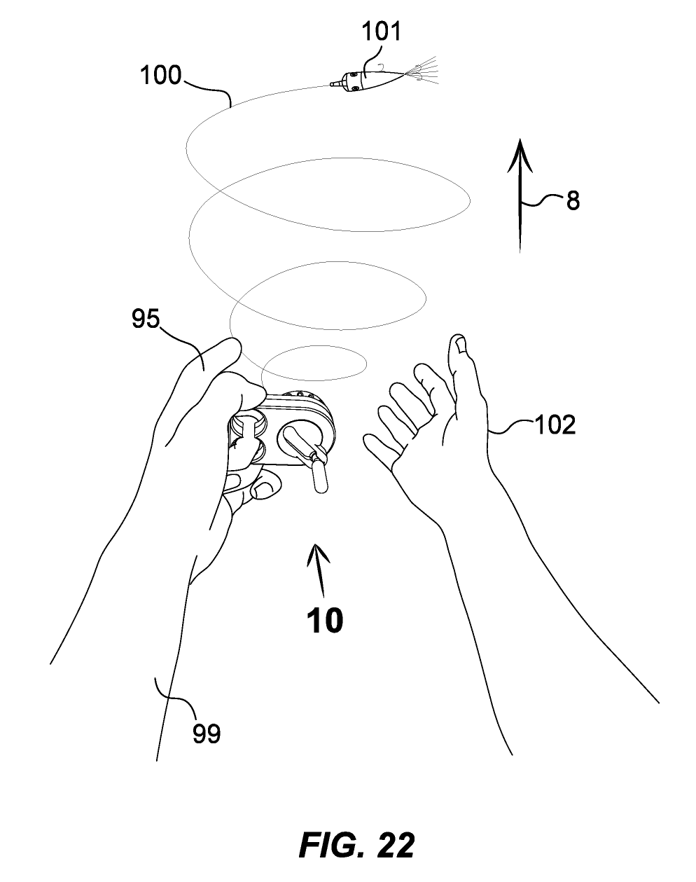

With attention to FIG. 20, in one exemplary operation of a fishing device 10 as shown in FIG. 1, a user 99 may hold the fishing device 10 by placing his/her middle finger in the lowermost aperture 13 and the index finger 95 on the spool 20 to prevent the fishing line 100 from unraveling, whereby the fishing lure 101, or hook with bait, freely hangs at the end of the fishing line 100 at a point below the fishing device 10. Next, as shown in FIG. 21, the user 99 grabs the fishing line 100 with the opposite hand 102 and pulls a desired length of the fishing line 100 out with the fishing lure 101 freely hanging below hand 102. From this position, the user 99 tosses, throws or casts the fishing lure 101 via the fishing line 100 toward a body of water 110 (see directional Arrow 8 in FIG. 22) while simultaneously releasing the index finger 95 from the spool 20 allowing the fishing line 100 to unwind or peel off of the outer brim 22 of the spool 20 directionally according to axis A-A. As illustrated, the spool 20 is suitably oriented forward away from the user 99 perpendicular to the fishing line 100. In this position, the first section 15 of the fishing device 10 faces the body of water 110 as shown.

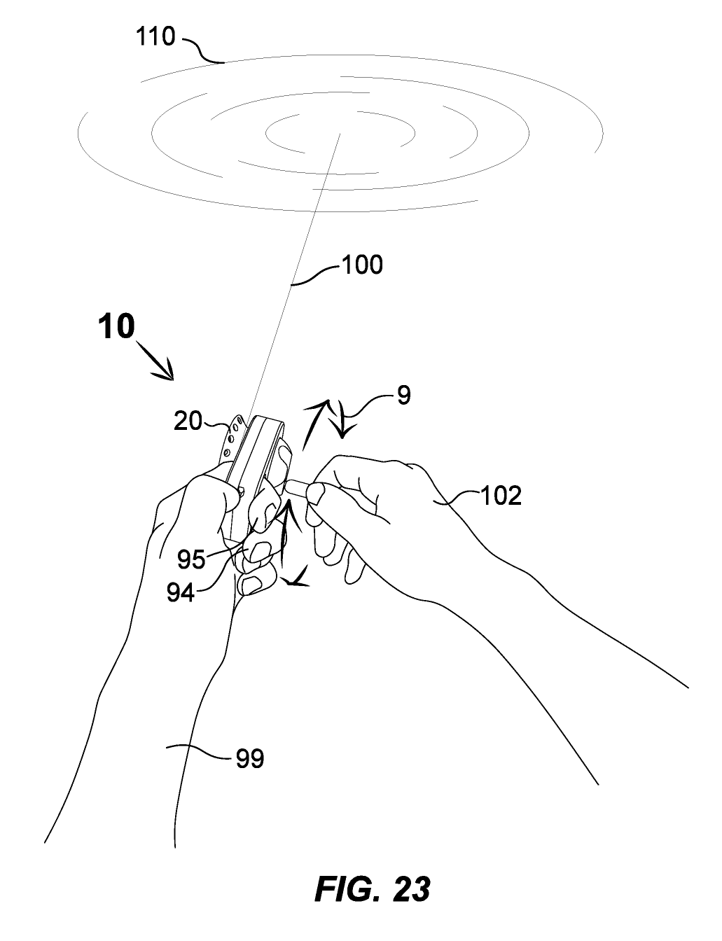

Referring to FIG. 23, during the act of fishing, the fishing device 10 is turned about ninety degrees so that the front 150 of the fishing device 10 faces the body of water 110 whereby the fishing line 100 lies substantially perpendicular to axis A-A allowing the fishing line 100 to easily be wound upon the winding surface 23 of the spool 20 as the user 99 turns the handle 30 with hand 102 according to directional Arrow 9 in an attempt to reel in the fishing line 100 alone or with a marine animal or object attached to the fishing lure 101. In addition, the index finger 95 may be set against the outer face 70 of the spool 20 in a manner effective to control the drag of the fishing line 100 when attempting to reel in a marine animal or object attached to the fishing lure 101. Herein, such activity is referred to as “manual drag.” In another embodiment, the fishing device 10 may incorporate mechanical drag between the central gear 40 and the spool 20 as described in U.S. Pat. No. 7,344,099, titled “Drag System for a Spinning Reel,” issued on Mar. 18, 2008, the content of which is herein incorporated by reference in its entirety.

Once the fishing lure 101 is retrieved, the user 99 may recast the fishing line 100 as describe above. Once a user 99 has finished using the fishing device 10, the fishing line 100 and fishing lure 101, or hook and/or bait, may be removed from the fishing device 10 for transportation and/or storage. In another embodiment, the fishing line 100 may be wound upon the winding surface 23 of the spool 20 to remove any slack in the line so that a fishing lure hook 105, hook, or fishing swivel may be mated with a spool hole 21 in a manner effective to substantially secure a fishing lure 101, hook, or fishing swivel in a fixed position during nonuse, e.g., transportation and/or storage, of the fishing device 10.

The individual component parts of the present fishing device 10 are suitably constructed from one or more materials effective to provide operative structural support in relation to fishing activities. In one implementation, the individual component parts of the fishing device 10 may be constructed from one or more like material(s) of construction. In another implementation, the individual component parts of the fishing device 10 may be constructed from one or more different materials of construction. Likewise, the component parts of the fishing device 10 may comprise any color or combination of colors, including but not necessarily limited to a plurality of camouflage patterns. In addition, the fishing device 10 may include one or more transparent and translucent component parts as desired.

One suitable fishing device 10 may be constructed from one or more materials including, but not necessarily limited to, those materials resistant to chipping, cracking, excessive bending and reshaping as a result of weathering, heat, moisture, other outside mechanical and chemical influences, as well as impacts and forces applied to the fishing device 10. Particular materials of construction may include, but are not necessarily limited to metals, plastics, rubbers, woods, fiberglass, plexiglass, filled composite materials, and combinations thereof. Suitable metals include, but are not necessarily limited steel, stainless steel, brass, titanium, aluminum, and alloys and combinations thereof. Suitable plastics include, but are not necessarily limited to (1) thermoplastic polymers, for example, acrylonitrile butadiene styrene (or “ABS”), polyvinyl chloride (or “PVC”), polyamide, e.g., nylon, polymethyl methacrylate (or “Acrylic”), polypropylene, polystyrene, low density polythene (or “LDPE”), high density polythene (or “HDPE”); (2) thermosetting polymers, for example, silicone and urea formaldehyde; (3) carbon fiber-reinforced plastics, and combinations thereof.

In one suitable embodiment, one or more of the individual component parts of the fishing device 10 may be provided as metal parts cut to form via a water jet, CNC machining, by hand, and combinations thereof. In another embodiment, one or more of the individual component parts of the fishing device 10 may be provided as plastic parts cut to form via a water jet, CNC machining, by hand, and combinations thereof. In another embodiment, one or more of the individual component parts of the fishing device 10 may be provided as cast mold or injection mold metal members. In another embodiment, one or more of the individual component parts of the fishing device 10 may be provided as cast mold or injection mold plastic members. In another embodiment, one or more of the individual component parts of the fishing device 10 may be carved from wood by lathe, CNC machine and/or by hand. In another embodiment, one or more of the individual component parts of the fishing device 10 may be 3D printed. Moreover, one or more gears, e.g., gears 73, 74, may be manufactured via a sheet metal stamping press or the like. In addition, one or more component parts of the fishing device 10 may be partially machined and finished by hand as desired.

Individual plastic component parts of the fishing device 10 may be adhered together via one or more adhesives. Desired adhesives include those that, after cure, can withstand the operating conditions of the present fishing device 10. Exemplary adhesives include, but are not necessarily limited to epoxy adhesives, silicone adhesives, urethane adhesives, including one-part and two-part urethane adhesives, acrylic adhesives, polyvinylbutyral adhesives, and combinations thereof. Individual metal component parts of the fishing device 10 may be welded together and/or adhered together as described above.

The central gear 40 and/or the spur gear 43 may be constructed from one or more of the above listed materials as desired or as otherwise required pursuant to an intended use of the fishing device 10. In one embodiment, the central gear 40 and the spur gear 43 may be constructed from like materials. In another embodiment, the main shaft 67 of the central gear 40 may be constructed from one or more first materials and the teeth 40A may be constructed from one or more second materials. Likewise, the axle 44 of the spur gear 43 may be constructed from one or more first materials and the teeth 43A may be constructed from one or more second materials. Furthermore, in one embodiment the teeth 50A of the ring gear 50 may be constructed from one or more materials similar as the drive member 25. In another embodiment, the teeth 50A of the ring gear 50 may be constructed from one or more materials similar as the teeth 40A of the central gear 40 and/or the teeth 43A of the spur gear 43. In one embodiment, the central gear 40 and/or the spur gear 43 may be provided as a one piece construction. In another embodiment, the axles of the central gear 40 and/or the spur gear 43 may be provided as separate component parts for assembly within axially aligned holes through the corresponding gears. In such embodiment, the axles and gears may be adhered together and/or welded together where constructed from metal. In another embodiment, a hole through the gear may include an inner diameter less than the outer diameter of the corresponding axle whereby the axle may be force fit within the hole in a manner effective to maintain the axle in a fixed position relative the gear during use thereof.

The invention will be better understood with reference to the following non-limiting examples, which are illustrative only and not intended to limit the present invention to a particular embodiment.

### Example 1

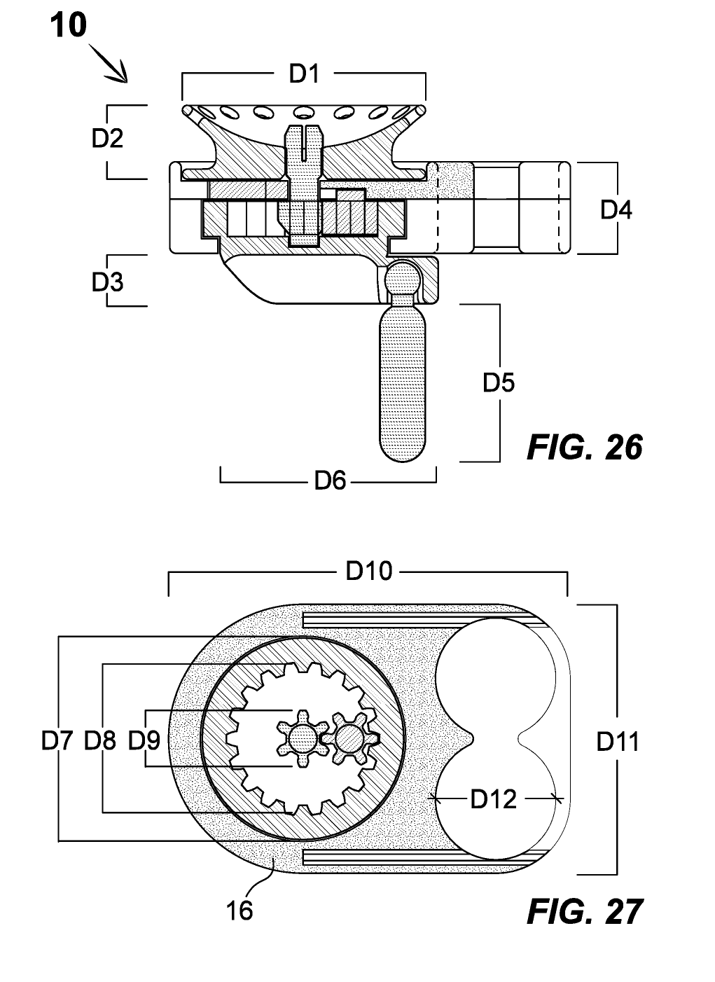

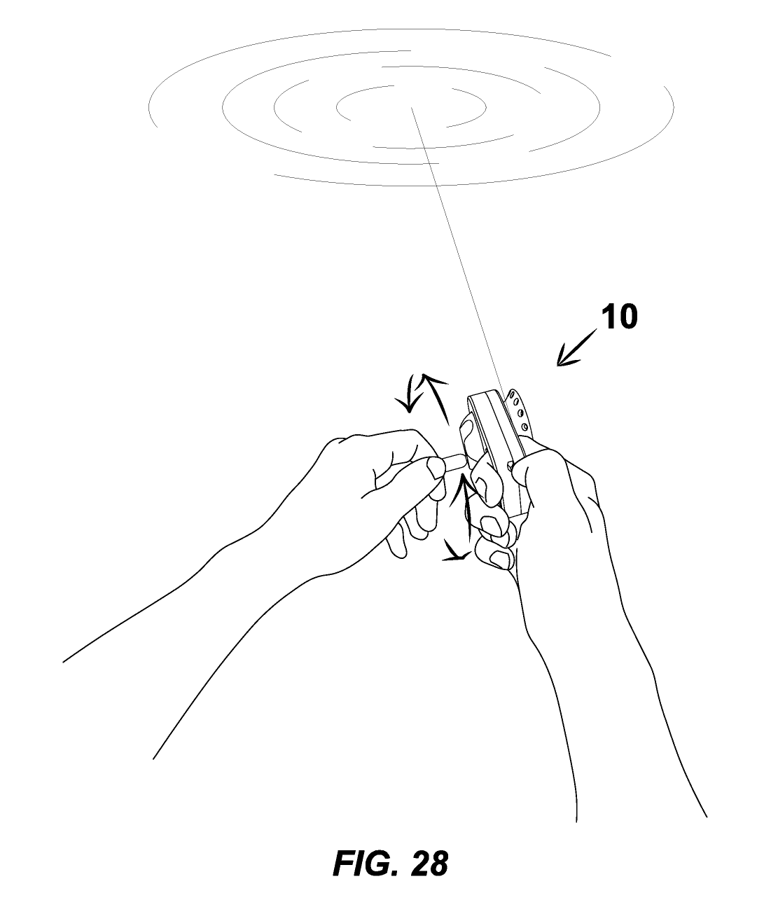

In a first non-limiting example, a fishing device 10 as shown in FIGS. 26-27, is provided having the following dimensions:
D1: 4.57 cm (1.80 inches)
D2: 1.40 cm (0.55 inches)
D3: 0.97 cm (0.38 inches)
D4: 1.73 cm (0.68 inches)
D5: 2.95 cm (1.16 inches)
D6: 4.06 cm (1.60 inches)
D7: 3.81 cm (1.50 inches)
D8: 2.87 cm (1.13 inches)
D9: 1.07 cm (0.42 inches)
D10: 7.62 cm (3.0 inches)
D11: 5.08 cm (2.0 inches)
D12: 2.29 cm (0.90 inches).

The following component parts of the fishing device 10 are constructed from the materials as provided below:
First Section 15: Acrylonitrile Butadiene Styrene
Second Section 16: Acrylonitrile Butadiene Styrene Spool 20: Acrylonitrile Butadiene Styrene
Crank Member 27: Acrylonitrile Butadiene Styrene Handle 30: Acrylonitrile Butadiene Styrene
Central Gear 40: Acrylonitrile Butadiene Styrene Spur Gear 43: Acrylonitrile Butadiene Styrene
Key Hole Filler 45: Acrylonitrile Butadiene Styrene

### Example 2

In a second non-limiting example, a fishing device 10 as shown in FIG. 25 is provided. Each of the component parts is constructed from metal. The fishing device 10 has a length of about 7.62 cm (about 3.0 inches).

### Example 3

In a third non-limiting example, a fishing device 10 is provided including the following materials of construction: the main body 12, the spool 20 and the drive member 25 of the fishing device 10 are constructed from plastic; the fasteners 19 are constructed from stainless steel; the central gear 40 includes teeth 40A constructed from brass and an axle 67 constructed from stainless steel; and the spur gear 43 includes teeth 43A constructed from brass and an axle 44 constructed from stainless steel.

### Example 4

In a fourth non-limiting example, a fishing device 10 as shown in FIG. 15 is provided including a main body 12, spool 20, drive member 25 and central shaft member 78, each of which is constructed from plastic.

It is further contemplated herein that the fishing device 10 of this application may include one or more fasteners for the attachment of a strap thereto allowing a user 99 to carry the fishing device 10 in a manner similar as a pouch, purse or the like. A suitable fastener and strap system for use herein is described in U.S. Pat. No. 5,307,967, titled “Article Carrier,” issued on May 3, 1994, the content of which is herein incorporated by reference in its entirety. In like manner, such a fastener and strap system may also be used as a body harness to prevent the fishing device 10 from being removed out from a user hands during use, e.g., a fish pulling the fishing device 10 out of a user's hands while being reeled in by the user. Other body harness configurations are contemplated for use herein including, for example, the harness as described in U.S. Pat. No. 3,326,430, titled “Harness,” issued on Jun. 20, 1967, the content of which is herein incorporated by reference in its entirety.

It is also contemplated that the present fishing device 10 may be provided with a storage container and/or travel case for housing the fishing device 10 when not in use. One particular container or case includes an inner surface corresponding to the shape of the fishing device 10 for securing the fishing device 10 therein. A container or case may also be provided in a size small enough to carry in a normal size pocket of a person's clothing.

Persons of ordinary skill in the art will recognize that many modifications may be made to the present invention without departing from the spirit and scope of the invention. The embodiment(s) described herein are meant to be illustrative only and should not be taken as limiting the invention, which is defined in the claims.

I claim:

1. A rodless fishing device, including:
a main body; and
an actuation assembly attached to the main body, the actuation assembly including a drive member, a gearing system and a spool.

2. The device of claim 1 wherein the gearing system is housed within the main body.

3. The device of claim 1 wherein the spool and the drive member are located on opposing sides of the main body.

4. The device of claim 1 wherein the spool and drive member are turnable about a first axis.

5. The device of claim 1 wherein the spool is turnable about a first axis and the drive member is turnable about a second axis.

6. The device of claim 1 wherein the main body is operationally configured to be held by a bare hand of an individual.

7. The device of claim 1 wherein the drive member includes a crank member and a handle pivotally attached to the crank member.

8. The device of claim 1 wherein the spool is defined by a central axis and includes an outer surface for winding fishing line thereon, the spool including an outer brim operationally configured for unwinding of fishing line off from the spool according to a direction parallel to the central axis of the spool.

9. The device of claim 1 wherein the spool includes an inner brim, the inner brim and main body forming a mating surface operationally configured to prevent fishing line from traveling between the spool and main body.

10. The device of claim 7 wherein the handle is operationally configured to be held by a first bare hand of an individual and the main body is operationally configured to be held by an opposing second bare hand of the individual.

11. The device of claim 7 wherein the handle is operationally configured to act on the gearing system in a manner effective to turn the spool.

12. The device of claim 1 wherein the gearing system includes a gear ratio advantage.
